(19) United States
(12) Patent Application Publication
(10) Pub. No.: US 2015/0277183 A1
(43) Pub. Date: Oct. 1, 2015

(54) DISPLAY PANEL AND MANUFACTURING METHOD THEREOF

(71) Applicant: InnoLux Corporation, Miao-Li County (TW)

(72) Inventors: Chao-Chun CHUNG, Miao-Li County (TW); Ting-I WU, Miao-Li County (TW); Jen-Chih LU, Miao-Li County (TW)

(21) Appl. No.: 14/633,665

(22) Filed: Feb. 27, 2015

(30) Foreign Application Priority Data
Mar. 27, 2014 (TW) 103111500

(51) Int. Cl. G02F 1/1333; G02F 1/1335; G02F 1/1341; G02F 1/1339; G02F 1/1337

(52) U.S. Cl. CPC G02F 1/133351; G02F 1/1339; G02F 1/1337; G02F 1/1341; G02F 1/133512; G02F 1/133528; G02F 2001/13415

(57) ABSTRACT

A display panel and a manufacturing method thereof are disclosed. The display panel includes a first substrate, a second substrate, a pixel array area and a sealing element. The first substrate has at least a first edge. The second substrate is disposed opposite to the first substrate. The pixel array area is configured between the first substrate and the second substrate and has at least a second edge partially overlapping with the first edge. The pixel array area includes a display area. The display area has at least a third edge corresponding to the second edge. The sealing element is disposed between the first substrate and the second substrate and corresponding to a periphery of the display area. The sealing element has at least a side partially located in the pixel array area.

### CROSS REFERENCE TO RELATED APPLICATIONS

This Non-provisional application claims priority under 35 U.S.C. §119(a) on Patent Application No(s). 103111500 filed in Taiwan, Republic of China on Mar. 27, 2014, the entire contents of which are hereby incorporated by reference.

### BACKGROUND

1. Technical Field

The present invention relates to a display panel and a manufacturing method thereof. In particularly, the present invention relates to a liquid crystal display panel and a manufacturing method thereof.

2. Related Art

As the progress of technology, the flat display devices have been widely applied to various fields. In particularly, the liquid crystal display device (TFT-LCD) has the advantages of light, thin, low power consumption and no radiation, so it has gradually taken the place of the conventional CRT display device and been applied to many electronic products such as mobile phones, portable multimedia devices, notebook computers, liquid crystal TVs, liquid crystal monitors, and the likes.

The conventional liquid crystal display device mainly includes an LCD panel and a backlight module disposed opposite to each other. The LCD panel includes a color filer substrate, a TFT (thin-film-transistor) substrate, and a liquid crystal layer disposed between two substrates. The color filer substrate, TFT substrate and liquid crystal layer form a plurality of pixels arranged in an array. The backlight module emits light, which passes through the LCD panel so as to form an image according to the colors of the pixels in the LCD panel.

During the manufacturing of the display panel, the photo mask corresponding to a specific dimension is used in the process. When the client needs the panels of different dimensions, the manufacturer has to design a new photo mask for manufacturing the products with the desired dimension. However, if the request amount of the panels with additional dimension is small, this solution of design a new photo mask, which causes additional cost, is not suitable. Another solution is to cut the larger sized assembled panel into desired size and then to perform the package process. However, this method will result in the leakage of liquid crystals and the pollution of the leaked liquid crystals. Besides, the cut panels are easily polluted by ions so as to decrease the reliability of the products.

### SUMMARY

An objective of the present invention is to provide s a display panel and a manufacturing method thereof that can customize the panels with different dimensions and avoid the problems (e.g. pollution and decreased reliability) caused by the leaked liquid crystals.

To achieve the above objective, the present invention discloses a display panel including a first substrate, a second substrate, a pixel array area and a sealing element. The first substrate has at least a first edge. The second substrate is disposed opposite to the first substrate. The pixel array area is configured between the first substrate and the second substrate and has at least a second edge partially overlapping with the first edge. The pixel array area includes a display area. The display area has at least a third edge corresponding to the second edge. The sealing element is disposed between the first substrate and the second substrate and corresponding to a periphery of the display area. The sealing element has at least a side partially located in the pixel array area.

In one embodiment, the display panel further includes an alignment layer disposed on the first substrate or the second substrate, and a width of the alignment layer along a direction is greater than or equal to a width of the display area along the direction.

In one embodiment, the display panel further includes a shielding element having a periphery shielding portion disposed on the second substrate and corresponding to a periphery of the pixel array area, and the sealing element has another side located corresponding to the periphery shielding portion.

In one embodiment, the display panel further includes at least a polarizer disposed on an outer surface of the first substrate or the second substrate.

To achieve the above objective, the present invention also discloses a manufacturing method of a display panel. The method includes the steps of: forming a TFT (thin-film-transistor) array on a first substrate and forming a color filter array corresponding to the TFT array on a second substrate; forming an alignment layer on the first substrate and the second substrate according to the range of a display area; forming a sealing element on the first substrate or the second substrate, wherein the sealing element is disposed around a periphery of the display area; attaching the first substrate and the second substrate correspondingly, wherein the TFT array and the color filter array form a pixel array area; and cutting along at least a side of the sealing element, wherein the side is partially located in the pixel array area.

In one embodiment, in the step of forming the alignment layer, a width of the alignment layer along a direction is greater than or equal to a width of the display area along the direction.

In one embodiment, in the step of forming the alignment layer, the display area is located in the pixel array area.

In one embodiment, the step of forming the sealing element on the first substrate or the second substrate further includes a step of filling liquid crystals in areas enclosed by the sealing element on the first substrate or the second substrate.

In one embodiment, after the step of cutting along the side of the sealing element, the first substrate has at least a first edge, the pixel array area has at least a second edge, and the second edge is partially overlapped with the first edge.

In one embodiment, the method further includes a step of attaching a polarizer on an outer surface of the first substrate or the second substrate.

As mentioned above, the display panel and manufacturing method thereof of the invention are to define the range of the display area according to the customized requirement before correspondingly assembling the first and second substrates, to form the alignment layer and sealing element according to the range of the display area, and then to cut along at least a side of the sealing element so that the side of the sealing element is partially located in the pixel array area. Accordingly, the desired customized dimension can be achieved. Compared with the conventional art, the invention does not need to design a new photo mask for various customized requirements or to cut a larger sized panel into the desired size before package. Thus, this invention can be free from the problem of pollution and decreased reliability caused by the leaked liquid crystals. As a result, the display panel and manufacturing method of the invention can customize the panels with different dimensions and avoid the problems (e.g. pollution and decreased reliability) caused by the leaked liquid crystals.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a flow chart of a manufacturing method of a display panel according to a preferred embodiment of the invention;

FIGS. 2A to 2E are schematic diagrams showing the manufacturing procedure of the display panel;

FIG. 3 is a flow chart of another manufacturing method of a display panel according to the preferred embodiment of the invention;

FIG. 4A is a top view of the processed display panel before performing a cutting step (step S05);

FIG. 4B is a top view of the processed display panel after the cutting step (step S05);

FIG. 4C is a sectional view along the line A-A of FIG. 4B;

FIG. 5A is a top view of another processed display panel before performing a cutting step (step S05); and

FIG. 5B is a top view of another processed display panel after the cutting step (step S05).

### DETAILED DESCRIPTION OF THE INVENTION

The embodiments of the invention will be apparent from the following detailed description, which proceeds with reference to the accompanying drawings, wherein the same references relate to the same elements.

All figures are for illustrations only and do not represent the real dimension and ratio. In addition, the figures show a direction X (horizontal direction), a direction Y (vertical direction) and a direction Z. Herein, the direction X and direction Y are the horizontal direction and vertical direction while viewing the panel from top, and the direction Z is substantially the direction perpendicular to both of the directions X and Y.

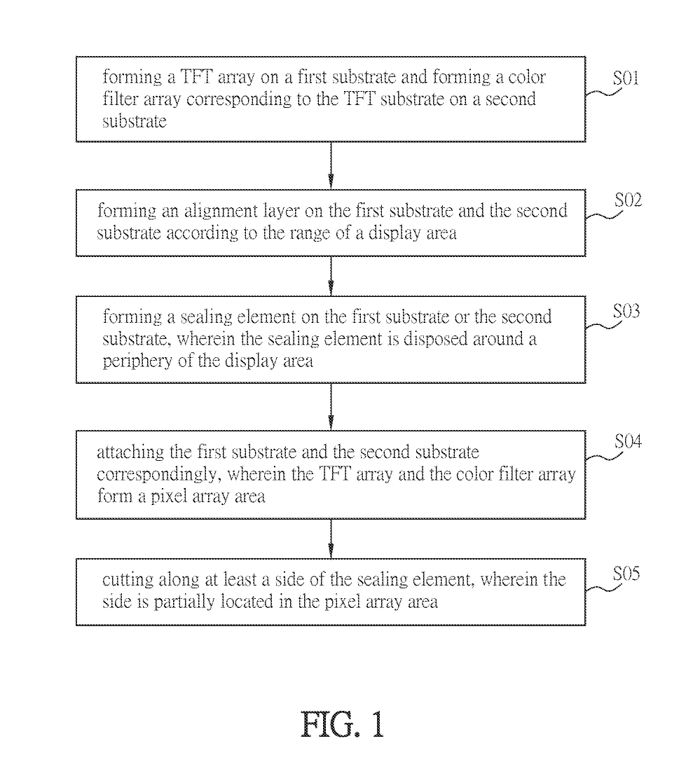

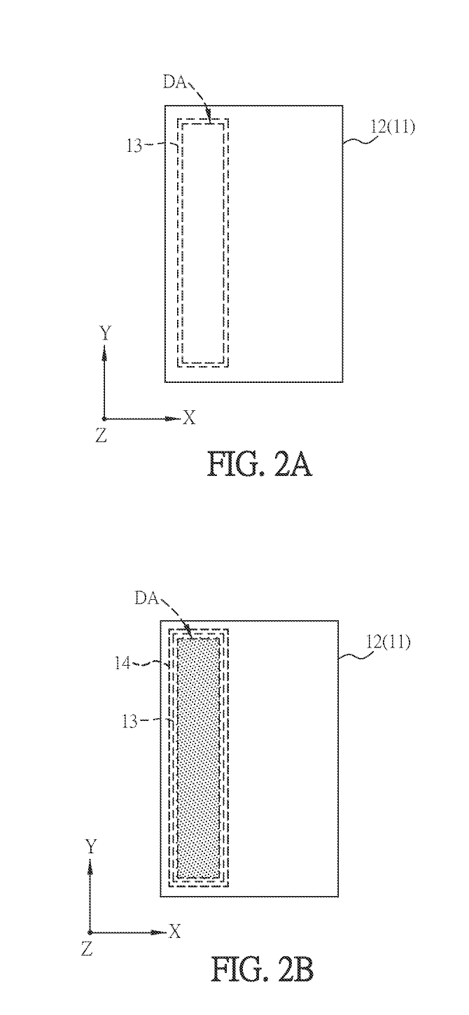

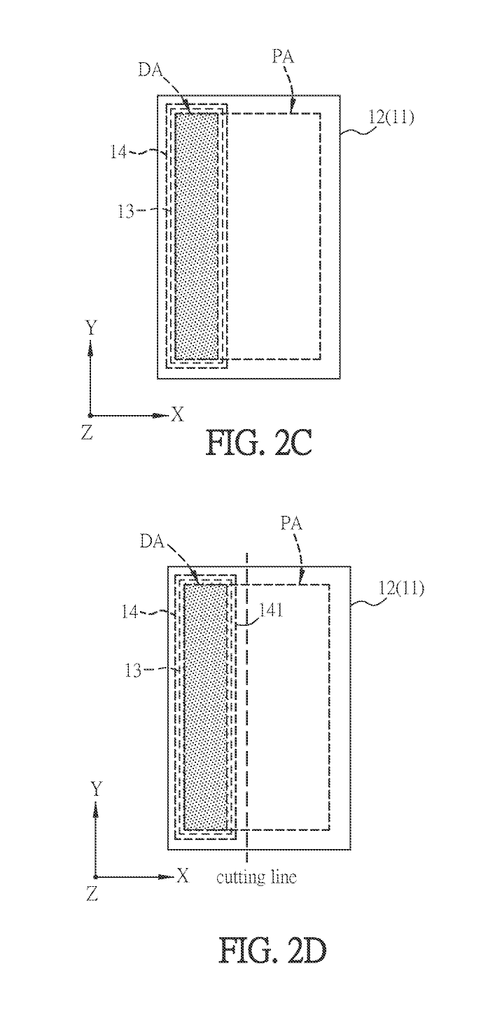

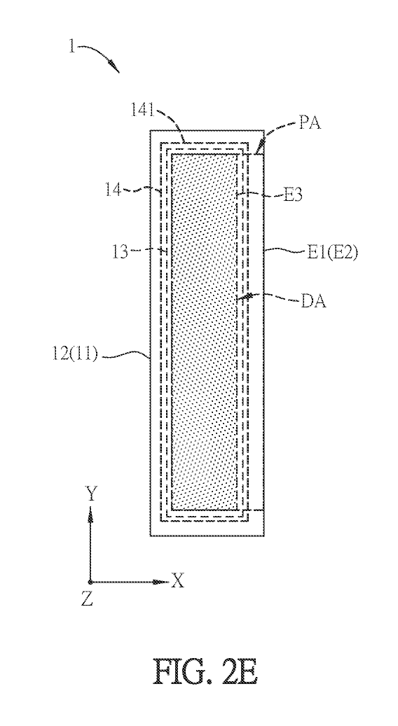

FIG. 1 is a flow chart of a manufacturing method of a display panel according to a preferred embodiment of the invention, and FIGS. 2A to 2E are schematic diagrams showing the manufacturing procedure of the display panel.

As shown in FIG. 1, the manufacturing method of a display panel includes the steps S01 to S05.

At first, the step S01 is to form a TFT (thin-film-transistor) array (not shown in FIGS. 2A-2E) on a first substrate 11 and to form a color filter array (not shown in FIGS. 2A-2E) corresponding to the TFT array on a second substrate 12. The first substrate 11 or the second substrate 12 is made of a transparent material such as glass, quartz or the likes, plastic, rubber, glass fiber or other polymer materials. Alternatively, the first substrate 11 or the second substrate 12 is made of an opaque material such as metal-glass fiber composite board, metal-ceramic composite board, printed circuit board or other materials. In this embodiment, the first substrate 11 and the second substrate 12 is made of glass. Herein, the first substrate 11 is configured with a TFT array so as to form a TFT substrate, while the second substrate 12 is configured with a color filter array so as to form a color filter substrate. To form the TFT array and the color filter array on the substrates is not the major feature of the invention, so the detailed description thereof will be omitted.

Next, the step S02 is to form an alignment layer 13 on the first substrate 11 and the second substrate 12 according to the range of a display area DA. The range of the display area DA is defined based on the requirement of client. The display area DA can be, for example, between 10% and 90% of the original display area. When forming the alignment layer 13, a width of the alignment layer 13 along a direction is greater than or equal to a width of the display area DA along the direction. In this embodiment, as shown in FIG. 2A, the widths of the alignment layer 13 along the direction X and direction Y are slightly greater than the widths of the display area DA along the direction X and direction Y, respectively. Thus, the area of the alignment layer 13 on the XY plane is also greater than that of the display area DA.

Afterwards, the step S03 is to form a sealing element 14 on the first substrate 11 or the second substrate 12, wherein the sealing element 14 is disposed around a periphery of the display area DA. Referring to FIG. 2B, the sealing element 14 is disposed to define an accommodating space, and the liquid crystal molecules are correspondingly disposed in the accommodating space enclosed by the sealing element 14. In the step of forming the sealing element 14 on the first substrate 11 or the second substrate 12 further includes a step of filling liquid crystals in areas enclosed by the sealing element 14 on the first substrate 11 or the second substrate 12 so as to form a liquid crystal layer. Herein, the liquid crystals can be filled on either substrate and this invention is not limited. This filling step can be performed by, for example but not limited to, a one drop filling (ODF) method for filling the liquid crystal molecules in the area enclosed by the sealing element 14. The sealing element 14 can be a thermosetting glue, a light curing adhesive or their combination. In this embodiment, the sealing element 14 is a light curing adhesive (e.g. UV adhesive). To be noted, although FIGS. 2A and 2B show that the first substrate 11 and the second substrate 12 are overlapped along the direction Z, the first substrate 11 and the second substrate 12 are still not correspondingly combined in the steps S01 to S03. FIGS. 2A and 2B only show the relative positions of the components.

After filling the liquid crystals, as shown in FIG. 2C, the step S04 is to attach the first substrate 11 and the second substrate 12 correspondingly, wherein the TFT array of the first substrate 11 and the color filter array of the second substrate 12 form a pixel array area PA. The display area DA is located within the pixel array area PA. In practice, the TFT array, the color filter array and the liquid crystal layer form the pixel array area PA.

Finally, the step S05 is to cut along at least a side 141 of the sealing element 14, wherein the side 141 is partially located in the pixel array area PA. The pixel array area PA has a plurality of pixels. In this embodiment, as shown in FIG. 2D, this step S05 is to cut along the outer edge of the side 141 so as to obtain a display panel 1 as shown in FIG. 2E. In other embodiments, it is also possible the cut along the edges of two sides of the sealing element 14 so as to obtain another display panel with different dimension. In the display panel 1, the first substrate 11 has a first edge E1, and the pixel array area PA has a second edge E2, which is partially overlapped with the first edge E1. In addition, the side 141 of the sealing element 14 is correspondingly located between the display area DA and the pixel array area PA.

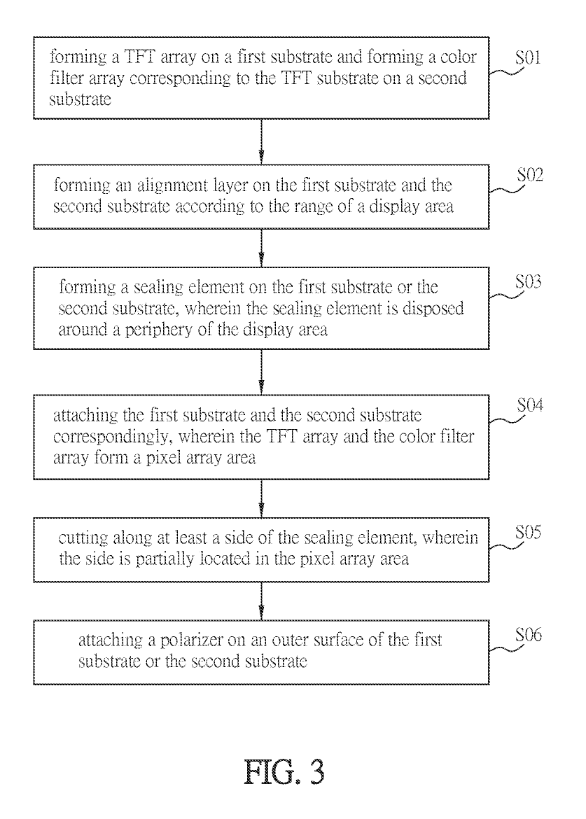

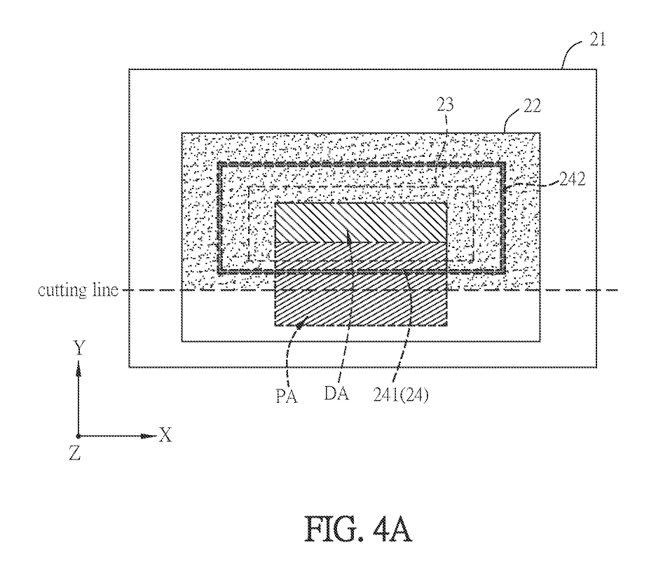

FIG. 3 is a flow chart of another manufacturing method of a display panel according to the preferred embodiment of the invention.

Different from the method shown in FIG. 1, the manufacturing method of FIG. 3 further includes a step S06, which is to attach a polarizer on an outer surface (not shown) of the first substrate 11 or the second substrate 12. In this embodiment, a polarizer is attached on the outer surface of the first substrate 11, and another polarizer is attached on the outer surface of the second substrate 12. Therefore, after assembling the display panel 1 configured with the polarizers to a backlight module, the backlight module can emit light to pass through the display panel 1 so as to form an image according to the colors of the pixels of the display panel 1.

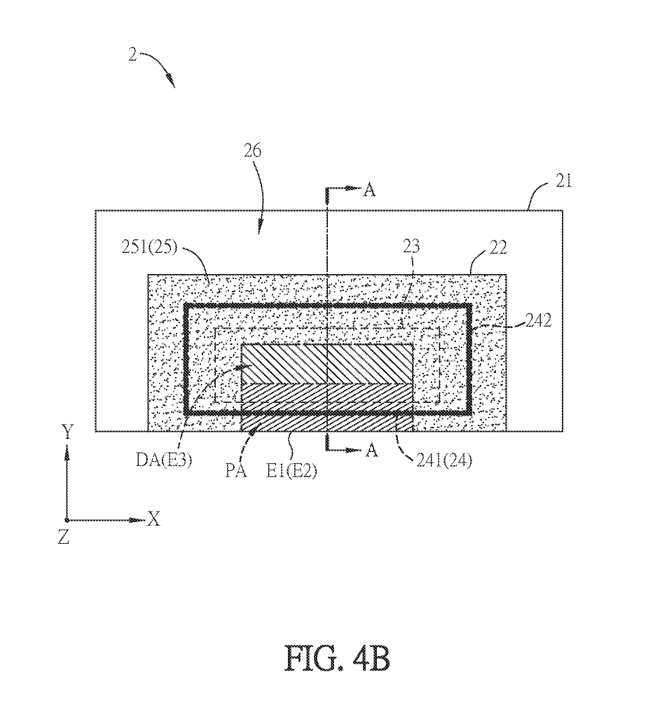

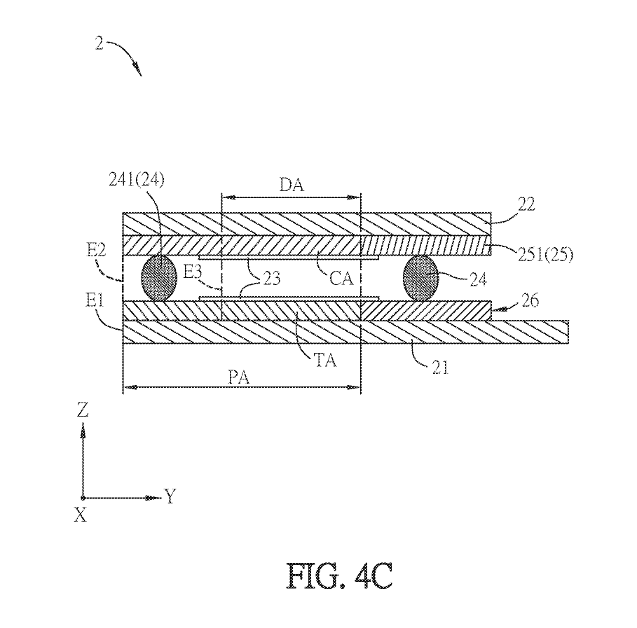

FIG. 4A is a top view of the processed display panel before performing a cutting step (step S05), FIG. 4B is a top view of the processed display panel 2 after the cutting step (step S05), and FIG. 4C is a sectional view along the line A-A of FIG. 4B. The display panel 2 is fabricated by the above-mentioned manufacturing method, and the steps of the manufacturing method can be referred to the above embodiment.

As shown in figures, the display panel 2 includes a first substrate 21, a second substrate 22, a pixel array area PA and a sealing element 24. In addition, the display panel 2 further includes an alignment layer 23, a light shielding element 25 and at least one polarizer (not shown).

The first substrate 21 is disposed opposite to the second substrate 22. The first substrate 21 has at least one first edge E1. In this embodiment, the first substrate 21 has one first edge E1 for example. Of course, in other embodiments, if the cutting step is to cut along two sides of the sealing element 24, the first substrate 21 correspondingly has two first edges E1.

The pixel array area PA is configured between the first substrate 21 and the second substrate 22. The pixel array area PA is formed by the TFT array TA on the first substrate 21, the color filter array CA on the second substrate 22, and the liquid crystal layer (not shown) between the first substrate 21 and the second substrate 22. Herein, the pixel array area PA is arranged in an array defined by a direction X and a direction Y. In addition, the display panel 2 further includes a plurality of scan lines and a plurality of data lines (not shown). The scan lines and the data lines are interlaced to define a plurality of pixels of the pixel array area PA. The pixel array area PA has at least one second edge E2. In this embodiment, the pixel array area PA has one second edge E2 for example. The second edge E2 is partially overlapped with the first edge E1. Moreover, the pixel array area PA includes a display area DA, which has at least one third edge E3 corresponding to the second edge E2. In this embodiment, the display area DA has one third edge E3 for example.

The sealing element 24 is disposed between the first substrate 21 and the second substrate 22 and correspondingly located at the periphery of the display area DA. The sealing element 24 has at least one side 241, which is partially located in the pixel array area PA. In this embodiment, the sealing element 24 has one side 241 located in the pixel array area PA. As shown in FIG. 4B viewing from the top of the display panel 2 (direction Z), the sides 241 of the sealing element 24 is correspondingly disposed between the first edge E1 (and the second edge E2) and the third edge E3.

The alignment layer 23 is disposed on the first substrate 21 or the second substrate 22. In this embodiment, the alignment layer 23 is disposed on the first substrate 21 and the second substrate 22. A width of the alignment layer 23 along the direction X or Y is greater than or equal to a width of the display area DA along the direction X or Y. In this embodiment, the width of the alignment layer 23 along the direction X is greater than the width of the display area DA along the direction X, and the width of the alignment layer 23 along the direction Y is greater than the width of the display area DA along the direction Y. In other words, the area of the alignment layer 23 on the XY plane is greater than that of the display area DA.

To be noted, the relationship between the alignment layer 23 and the sealing element 24 is not limited in this invention. In this embodiment, as shown in FIG. 4C, the alignment layer 23 does not extend to the sealing element 24 along the Y direction. That is, the alignment layer 23 does not contact (or overlapped) with the sealing element 24. Of course, in other embodiments, the alignment layer 23 can extend to or beyond the sealing element 24 along the Y direction (the alignment layer 23 and the sealing element 24 are overlapped), and this invention is not limited.

The shielding element 25 is disposed on the first substrate 21 or the second substrate 22. The shielding element 25 can be an opaque black matrix layer, which is made of metal or resin. In this embodiment, the shielding element 25 is disposed on the second substrate 22. Of course, in other embodiment, the shielding element 25 can be disposed on the first substrate 21 so as to form a BOA (BM on array) substrate, and this invention is not limited. The shielding element 25 is disposed at one side of the second substrate 22 facing the first substrate 21. In the display area DA, the shielding element 25 has a plurality of shielding sections (not shown), and at least one shielding section is configured between two adjacent filtering portions. Since the shielding element 25 is made of opaque material, the second substrate 22 can be formed with opaque areas so as to define the transparent areas. In addition, the shielding element 25 further has a periphery shielding portion 251 disposed on the second substrate 22 and corresponding to a periphery of the pixel array area PA. Besides, the sealing element 24 has another side 242 located corresponding to the periphery shielding portion 251. In this embodiment, the sealing element 24 has three second sides 242 all corresponding to the periphery shielding portion 251. Moreover, the position corresponding to the side 241 disposed in the pixel array area PA is not configured with the periphery shielding portion 251. Therefore, the side 241 of the sealing element 24 is not corresponding to any periphery shielding portion 251, it is necessary to provide a control signal to display a black image corresponding to the side 241 of the sealing element 24 for creating a virtual shielding element.

The polarizer is disposed on the outer surface of the first substrate 21 or the second substrate 22. In this embodiment, a polarizer is attached on the outer surface of the first substrate 21, and another polarizer is attached on the outer surface of the second substrate 22. As shown in FIG. 4C, the first substrate 21 is further configured with a circuit area 26, which is located at one side of the first substrate facing the first edge E1, and the driving circuit (not shown) can be disposed in the circuit area 26. The driving circuit, for example, includes a data driving IC and is formed in the circuit area 26 corresponding to the periphery shielding portion 251 by COF or COG technology.

The other technical features of the display panel 2 can be referred to the same components of the above-mentioned display panel 1, so the detailed description thereof will be omitted.

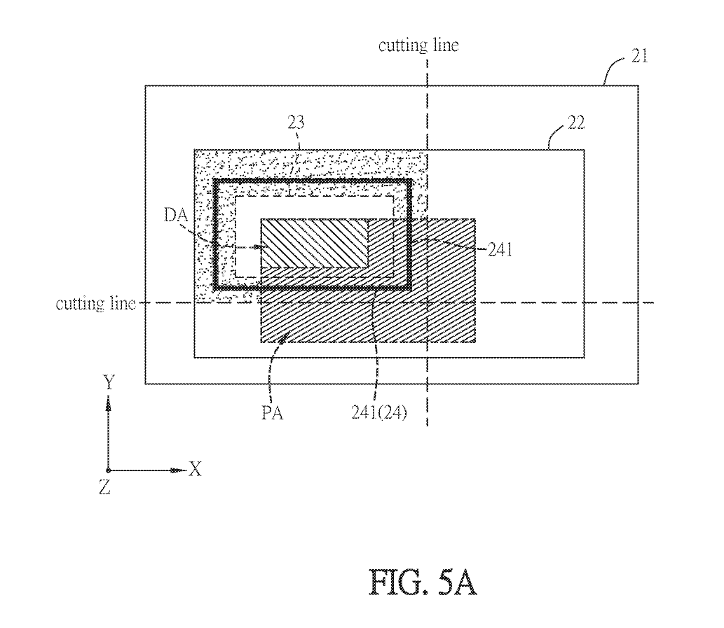

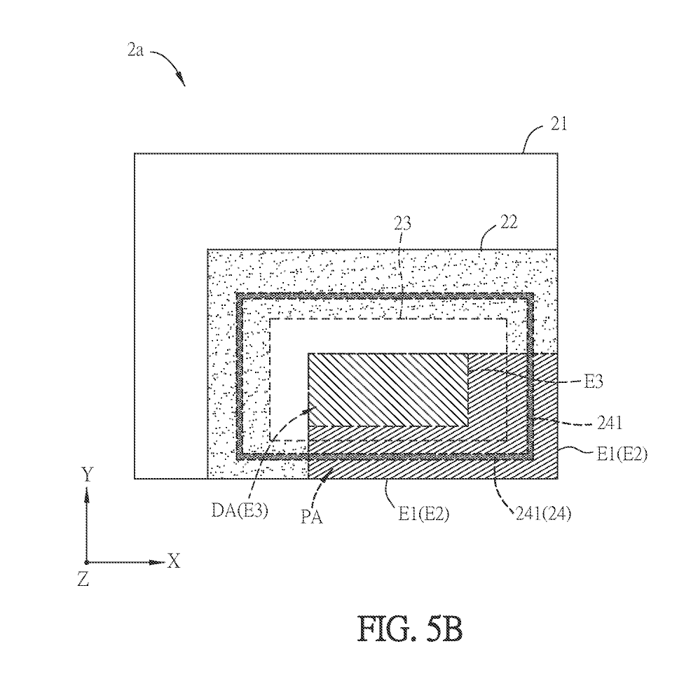

FIG. 5A is a top view of another processed display panel before performing a cutting step (step S05), and FIG. 5B is a top view of another processed display panel after the cutting step (step S05) so as to obtain another display panel 2a.

In this embodiment, the display area DA has a smaller size, so the step S05 is to perform the cutting process along two sides 241 of the sealing element 24 (see FIG. 5A) so as to obtain the display panel 2a as shown in FIG. 5B. In this display panel 2a, the first substrate 21 has two first edges E1, and the pixel array area PA has two second edges E2, which are partially overlapped with the first edges E1, respectively. In addition, the display area DA also has two third edges E3 corresponding to the second edges E2, respectively.

The other technical features of the display panel 2a can be referred to the same components of the above-mentioned display panel 2, so the detailed description thereof will be omitted.

In summary, the display panel and manufacturing method thereof of the invention are to define the range of the display area according to the customized requirement before correspondingly assembling the first and second substrates, to form the alignment layer and sealing element according to the range of the display area, and then to cut along at least a side of the sealing element so that the side of the sealing element is partially located in the pixel array area. Accordingly, the desired customized dimension can be achieved. Compared with the conventional art, the invention does not need to design a new photo mask for various customized requirements or to cut a larger sized panel into the desired size before package. Thus, this invention can be free from the problem of pollution and decreased reliability caused by the leaked liquid crystals. As a result, the display panel and manufacturing method of the invention can customize the panels with different dimensions and avoid the problems (e.g. pollution and decreased reliability) caused by the leaked liquid crystals.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display panel, comprising:
a first substrate having at least a first edge;
a second substrate disposed opposite to the first substrate;
a pixel array area configured between the first substrate and the second substrate and having at least a second edge partially overlapping with the first edge, wherein the pixel array area comprises a display area, and the display area has at least a third edge corresponding to the second edge; and
a sealing element disposed between the first substrate and the second substrate and corresponding to a periphery of the display area, wherein the sealing element has at least a side partially located in the pixel array area.

2. The display panel of claim 1, further comprising:
an alignment layer disposed on the first substrate or the second substrate, wherein a width of the alignment layer along a direction is greater than or equal to a width of the display area along the direction.

3. The display panel of claim 1, further comprising:
a shielding element having a periphery shielding portion disposed on the second substrate and corresponding to a periphery of the pixel array area, wherein the sealing element has another side located corresponding to the periphery shielding portion.

4. The display panel of claim 1, further comprising:
at least a polarizer disposed on an outer surface of the first substrate or the second substrate.

5. A manufacturing method of a display panel, comprising the steps of:
forming a TFT (thin-film-transistor) array on a first substrate and forming a color filter array corresponding to the TFT array on a second substrate;
forming an alignment layer on the first substrate and the second substrate according to the range of a display area;
forming a sealing element on the first substrate or the second substrate, wherein the sealing element is disposed around a periphery of the display area;
attaching the first substrate and the second substrate correspondingly, wherein the TFT array and the color filter array form a pixel array area; and
cutting along at least a side of the sealing element, wherein the side is partially located in the pixel array area.

6. The method of claim 5, wherein in the step of forming the alignment layer, a width of the alignment layer along a direction is greater than or equal to a width of the display area along the direction.

7. The method of claim 5, wherein in the step of forming the alignment layer, the display area is located in the pixel array area.

8. The method of claim 5, wherein the step of forming the sealing element on the first substrate or the second substrate further comprises a step of:
filling liquid crystals in areas enclosed by the sealing element on the first substrate or the second substrate.

9. The method of claim 5, wherein after the step of cutting along the side of the sealing element, the first substrate has at least a first edge, the pixel array area has at least a second edge, and the second edge is partially overlapped with the first edge.

10. The method of claim 5, further comprising a step of:
attaching a polarizer on an outer surface of the first substrate or the second substrate.
